(19) United States
(12) Patent Application Publication
(10) Pub. No.: US 2003/0129419 A1
(43) Pub. Date: Jul. 10, 2003

(54) Stain resistant treatment for porous substrates

(75) Inventor: Yen-Lane Chen, New Brighton, MN (US)

Correspondence Address: Peter Olson, Esq., 3M Innovative Properties Company, 3M Center, Bldg. 220, P.O. Box 33427, St. Paul, MN, 55133-3427, US

(73) Assignee: 3M Innovative Properties Company

(21) Appl. No.: 10/001,079

(22) Filed: Oct. 30, 2001

(51) Int. Cl. B32B 9/04

(52) U.S. Cl. 428/447

(57) ABSTRACT

An aqueous composition that includes silane including n-alkylalkoxysilane, condensates of n-alkylalkoxysilane or a combination thereof, and from about 0.01 % by weight to about 2 % by weight cationic quaternary surfactant. The composition optionally includes a siloxane selected from the group consisting of methylhydrogen siloxane, methylhydrogen-methylalkyl siloxane copolymer, methylhydrogen-cyclosiloxane copolymer, methylhydrogen-methylalkyl cyclosiloxane copolymer and combinations thereof, and volatile carrier.

### BACKGROUND OF THE INVENTION

The invention is directed to imparting stain resistance and water and oil repellency to porous substrates.

Highly porous substrates such as grout, tile, marble, concrete, brick and stone are used extensively in the construction of flooring, counter tops, buildings, garage floors, driveways and swimming pools. When left unprotected, these substrates often discolor from exposure to soil, water-based stains and oil-based stains. These porous substrates are particularly susceptible to stains from oil, bodily fluids such as urine and blood, food stuff, soap scum, and components in water such as iron and calcium. The growth of fungus and bacteria in high humidity environments can also discolor these porous substrates.

The porosity of these substrates renders it very difficult to clean and to remove stains and discoloration from them. Grout, in particular, is difficult to clean due to its porous nature and generally rough surface.

Various compositions have been developed in an effort to treat these porous substrates to render them waterproof or more water repellant. Waterproofing compositions often include film forming components such as polyvinyl chloride, polyethylene and polyurethane, which tend to change the appearance of the treated surface. Waterproofing compositions can also trap moisture within the treated surface, which then promotes fungal and bacterial growth.

Water repellent compositions usually include acrylates, silicone, siliconates, silanes and fluorochemicals. Water repellent compositions based on silicone chemistry provide water repellency, however, they often lack oil repellency and stain resistance.

### SUMMARY

In one aspect, the invention features an aqueous composition that includes silane including n-alkylalkoxysilane, condensates of n-alkylalkoxysilane or a combination thereof; and from about 0.01% by weight to about 2% by weight cationic quaternary ammonium surfactant. In one embodiment the silane is n-octyltrialkoxysilane. In other embodiments, the silane is selected from the group consisting of n-octyltriethoxysilane and n-octyltrimethoxysilane.

In some embodiments, the cationic quaternary ammonium surfactant includes monoalkyl trimethyl quaternary ammonium compound. In other embodiments, the cationic quaternary ammonium surfactant is selected from the group consisting of dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

In one embodiment, the cationic quaternary ammonium surfactant includes a quaternary ammonium compound having the formula

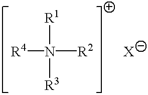

where R¹ is a methyl group or a saturated or unsaturated aliphatic group containing from 8 to 22 carbon atoms, R² is a methyl group, a saturated or unsaturated aliphatic group containing from 8 to 22 carbon atoms, R′n or C(X¹)₂-benzyl where X¹ is hydrogen or halogen including, for example, chlorine or bromine, R³ is a methyl group or a saturated or unsaturated aliphatic group containing from 8 to 22 carbon atoms, R⁴ is a methyl group, a saturated or unsaturated aliphatic group containing from 8 to 22 carbon atoms or R′n, R′ is 2-hydroxyethyl or polyethoxyethanol, n is from 1 to 50 oxyalkylene units, at least one of R¹, R², R³ and R⁴, is a methyl group and at least one of R¹, R², R³ and R⁴ is a saturated or unsaturated aliphatic group containing from 8 to 22 carbon atoms, and X is chlorine, bromine, methyl sulfate, phosphate, hydroxide or nitrate.

In some embodiments, the cationic quaternary ammonium surfactant includes a quaternary ammonium compound having the formula

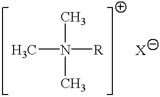

where R is a saturated or unsaturated aliphatic group containing from 8 to 22 carbon atoms, and X is chlorine, bromine, methyl sulfate, phosphate, hydroxide or nitrate.

In other embodiments, the cationic quaternary ammonium surfactant includes a quaternary ammonium compound having the formula

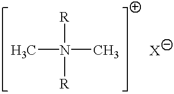

where each R is a linear or branched, saturated or unsaturated aliphatic group containing from 8 to 22 carbon atoms, and X is chlorine, bromine, methyl sulfate, phosphate, hydroxide or nitrate.

In some embodiments, the cationic quaternary ammonium surfactant includes a quaternary ammonium compound having the formula

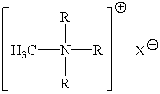

where each R is a linear or branched, saturated or unsaturated aliphatic group containing from 8 to 22 carbon atoms, and X is chlorine, bromine, methyl sulfate, phosphate, hydroxide or nitrate.

In one embodiment, the cationic quaternary ammonium surfactant includes a quaternary ammonium compound having the formula

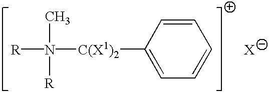

where each R is a linear or branched, saturated or unsaturated aliphatic group containing from 8 to 22 carbon atoms, X¹ is hydrogen or halogen, and X is chlorine, bromine, methyl sulfate, phosphate, hydroxide or nitrate.

In other embodiments, the cationic quaternary ammonium surfactant includes a quaternary ammonium compound having the formula

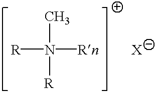

where each R is a linear or branched, saturated or unsaturated aliphatic group containing from 8 to 22 carbon atoms, R′ is 2-hydroxyethyl or polyethoxyethanol, n is from 1 to 50 polyoxyalkylene units, and X is chlorine, bromine, methyl sulfate, phosphate, hydroxide or nitrate.

In some embodiments, the cationic quaternary ammonium surfactant includes cationic quaternary ammonium compound having the formula

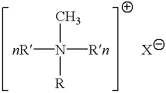

where, each R is a linear or branched, saturated or unsaturated aliphatic group containing from 8 to 22 carbon atoms, R′ is 2-hydroxyethyl or polyethoxyethanol, n is from 1 to 50 oxyalkylene units, and X is chlorine, bromine, methyl sulfate, phosphate, hydroxide or nitrate.

In other embodiments, the cationic quaternary ammonium surfactant includes organosilane quaternary ammonium compound. In some embodiments, the cationic quaternary ammonium surfactant includes fluoroalkyl quaternary ammonium compound.

In some embodiments, the composition includes from about 0.01% by weight to about 0.5% by weight the cationic quaternary ammonium surfactant. In other embodiments, the ratio of the n-octyltriethoxysilane to the cationic quaternary ammonium surfactant is from about 1:1 to about 10:1. In another embodiment, the ratio of the n-octyltriethoxysilane to the cationic quaternary ammonium surfactant is from about 1:1 to about 5:1.

In other embodiments, the composition further includes siloxane that includes methylhydrogen siloxane, methylhydrogen-methylalkyl siloxane copolymer, methylhydrogen-cyclosiloxane copolymer, methylhydrogen-methylalkyl cyclosiloxane copolymer or a combination thereof.

In another embodiment, the composition further includes a volatile carrier. In one embodiment, the volatile carrier includes cylcomethicone having the formula

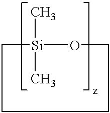

where z=4 to 6, for example, octamethylcyclotetrasiloxane.

In one embodiment, the composition further includes nonionic surfactant, for example, polyoxyethylene alcohol, ethoxylated nonyl phenol, sorbitan fatty acid ester, fatty acid glycerides, polyoxyethylene sorbitan fatty acid esters and combinations thereof. In other embodiments, the composition is essentially free of nonionic surfactant and anionic surfactant.

In another embodiment, the composition includes from about 0.1% by weight to about 3% by weight silane selected from the group consisting of n-alkylalkoxysilane, condensates of n-alkylalkoxysilane and combinations thereof. In other embodiments, the composition includes from about 0.01% by weight to about 0.5% by weight the cationic quaternary ammonium surfactant. In one embodiment, the ratio of the silane to cationic quaternary ammonium surfactant is from about 1:1 to about 10:1. In some embodiments, the ratio of the silane to the cationic quaternary ammonium surfactant is from about 1:1 to about 5:1.

In another aspect, the invention features an aqueous composition that includes a first siloxane selected from the group consisting of methyl hydrogen siloxane, methylhydrogen-methylalkyl siloxane copolymer, methylhydrogen-cyclosiloxane copolymer, methylhydrogen-methylalkyl cyclosiloxane copolymer and combinations thereof, silane that includes n-alkylalkoxysilane, condensates of n-alkylalkoxysilane or a combination thereof, volatile carrier, and cationic quaternary ammonium surfactant. In one embodiment, the silane includes n-octyltrialkoxysilane. In other embodiments, the silane is selected from the group consisting of n-octyltriethoxysilane and n-octyltrimethoxysilane. In one embodiment, the ratio of the silane to the cationic quaternary ammonium surfactant is from about 1:1 to about 10:1. In other embodiments, the ratio of the silane to the cationic quaternary ammonium surfactant is from about 1:1 to about 5:1. In another embodiment, the volatile carrier includes cyclomethicone, for example, octamethylcyclotetrasiloxane. In some embodiments, the composition is essentially free of nonionic surfactant and anionic surfactant.

In one embodiment, the aqueous composition that includes methylhydrogen siloxane, octamethylcyclotetrasiloxane, n-octyltriethoxysilane and cationic quaternary ammonium surfactant.

In some embodiments the aqueous composition includes methylhydrogen siloxane, octamethylcyclotetrasiloxane, n-octyltriethoxysilane, and cationic quaternary ammonium organosilane compound.

In another aspect, the invention features a method of treating a porous substrate, the method that includes contacting a porous substrate with an aqueous composition that includes silane that includes n-alkylalkoxysilane, condensates of n-alkylalkoxysilane or a combination thereof, and from about 0.01% by weight to about 2% by weight cationic quaternary surfactant and drying the coated substrate. In one embodiment, the method further includes cleaning the porous substrate prior to contacting the porous substrate with the aqueous composition. In some embodiments, the porous substrate is selected from the group consisting of grout, plaster, stucco, concrete, tile, brick, stone, glass and combinations thereof. In other embodiments, the stone is selected from the group consisting of slate, marble, terrazzo, granite, limestone, and combinations thereof.

In other aspects, the invention features an article that includes a porous substrate, and a composition disposed on the porous substrate, the composition including silane that includes n-alkylalkoxysilane, condensates of n-alkylalkoxysilane or a combination thereof, and from about 0.01% by weight to about 2% by weight cationic quaternary ammonium surfactant. In one embodiment, the composition is chemically bonded to the porous substrate. In other embodiments, the porous substrate is selected from the group consisting of grout, plaster, stucco, concrete, tile, brick, stone, glass and combinations thereof. In some embodiments, the porous is selected from the group consisting of slate, marble, terrazzo, granite, limestone, and combinations thereof.

In another aspect, the invention features a stain resistant composition that includes silane that includes n-alkylalkoxysilane, condensates of n-alkylalkoxysilane or a combination thereof, and from about 0.01% by weight to about 2% by weight cationic quaternary surfactant, the composition imparting greater stain resistance to a porous substrate treated with the composition relative to the stain resistance of the untreated porous substrate.

The composition imparts stain resistance including oil-based and water-based stain resistance to porous substrates and is particularly well suited for use on porous siliceous substrates. Substrates treated with the composition also exhibit good oil and water repellency. The composition also is a good deterrent to bacteria and fungi growth on surfaces on which the composition is applied. The composition can be formulated such that the aesthetics (including, for example, the degree of shine) of the substrate prior to treatment are maintained after application of the composition to the substrate.

Other features and advantages will be apparent from the following description of the preferred embodiments and from the claims.

### DETAILED DESCRIPTION

The aqueous composition is an emulsion and includes silane (for example, n-alkylalkoxysilane, condensates of n-alkylalkoxysilane or a combination thereof), cationic quaternary ammonium surfactant and water. The composition optionally also includes siloxane and volatile carrier. The composition can be applied to a substrate and, when dry, includes the reaction product of the silane, the quaternary cationic surfactant, when present as an organosilane quaternary ammonium surfactant, and the siloxane, when present. The composition imparts stain resistance, oil repellancy and water repellancy to the treated substrate. Preferably the composition penetrates the pores of the surface and provides protection from staining agents including, for example, dirt, oil, grease, food stuff, soap scum, bodily fluids, and components in water including, for example, calcium and iron.

Suitable n-alkylalkoxysilanes have the general formula R¹Si(R²)₄₋ₐ where R¹ is a straight or branched halogenated or nonhalogenated group having from 1 to 18 carbon atoms, R² is a hydrolyzable group including, for example, from 1 to 3 carbon atoms, alkoxy, halide, amino and carboxylate, and a=1 to 3. Useful n-alkylalkoxysilanes include n-octyltriethoxysilane, n-octyltrimethoxysilane and condensates and mixtures thereof. The composition preferably includes silane in an amount of from 0.1% by weight to about 15% by weight, more preferably from about 0.1% by weight to about 10% by weight, most preferably from 0.5% by weight to about 5% by weight.

Useful cationic quaternary ammonium surfactants include organosilane quaternary ammonium compounds having the formula [R¹₄₋ₙSi(CH₂)ᵥ—N(R²)₃]X, where R¹ is an alkoxy group, for example, methoxy and ethoxy, n is from 1 to 4, v is from 2 to 4, each R² is, independently, a branched or unbranched, substituted or unsubstituted aliphatic group having from 1 to 20 carbon atoms (preferably from 1 to 6 carbon atoms or from 10 to 20 carbon atoms, more preferably from 1 to 4 carbon atoms or from 14 to 18 carbon atoms) and X is chlorine, bromine, methyl sulfate, phosphate, hydroxide or nitrate. A suitable organosilane quaternary ammonium surfactant is available under the trade designation AEM 5772 3-trimethoxysilylpropyldimethyloctadecyl ammonium chloride from Aegis Environment (Midland, Mich.) and Bioshield (Norcross, Ga.).

Examples of other suitable cationic quaternary ammonium surfactants include monoalkyl trimethyl quaternary ammonium compounds, dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof. Suitable examples of quaternary ammonium surfactants include octadecyltrimethyl ammonium chloride, coco trimethyl ammonium chloride, tallow trimethyl ammonium chloride, dimethyl 80% behenyl benzyl ammonium chloride, soya trimethyl ammonium chloride, methyl bis(2-hydroxyethyl)coco ammonium chloride, dehydrogenated tallow dimethyl ammonium chloride, methyldodecylbenzyl trimethyl ammonium chloride, lauryldimethylbenzyl ammonium chloride, alkyldimethyl-3,4-dichloro-benzyl ammonium chloride, octylphenoxyethoxyethyl dimethyl-benzyl ammonium chloride, octylcresoxyethoxyethyl dimethyl-benzyl ammonium chloride, cocoamidopropyl pg-dimonium chloride, 2-hydroxyethylbenzyl stearyl imidazolinium chloride, 1-hexadecylpyridinium chloride, cetylpyridinium bromide, stearyl dimethyl benzyl ammonium chloride, olealkonium chloride, fluoroalkyl quaternary ammonium compounds, and combinations thereof.

Useful cationic quaternary ammonium compounds include:

monoalkyl trimethyl quaternary ammonium compounds having the formula

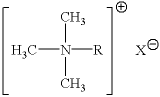

where R is a saturated or unsaturated aliphatic group containing from 8 to 22 carbon atoms, and X is chlorine, bromine, methyl sulfate, phosphate, hydroxide or nitrate;

dialkyl dimethyl quaternary ammonium compounds having the formula:

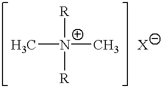

where each R is a linear or branched, saturated or unsaturated aliphatic group containing from 8 to 22 carbon atoms, and X is chlorine, bromine, methyl sulfate, phosphate, hydroxide or nitrate;

trialkyl monomethyl quaternary ammonium compound having the formula:

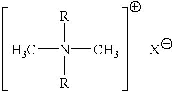

where each R is a linear or branched, saturated or unsaturated aliphatic group containing from 8 to 22 carbon atoms, and X is chlorine, bromine, methyl sulfate, phosphate, hydroxide or nitrate;

benzyl quaternary ammonium compounds having the formula:

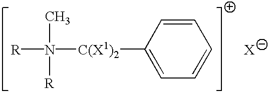

where each R is a linear or branched, saturated or unsaturated aliphatic group containing from 8 to 22 carbon atoms, X¹ is hydrogen or halogen (for example, chlorine and bromine) and X chlorine, bromine, methyl sulfate, phosphate, hydroxide or nitrate;

alkoxy alkyl quaternary ammonium compounds having the formula:

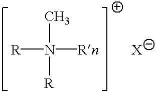

where each R is a linear or branched, saturated or unsaturated aliphatic group containing from 8 to 22 carbon atoms, R′ is 2-hydroxyethyl or polyethoxyethanol, n is from a 1 to 50 oxyalkylene units, and X is chlorine, bromine, methyl sulfate, phosphate, hydroxide or nitrate;

alkoxy alkyl quaternary ammonium compounds having the formula:

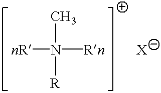

where, each R is a linear or branched, saturated or unsaturated aliphatic group containing from 8 to 22 carbon atoms, R′ is 2-hydroxyethyl or polyethoxyethanol, n is from 1 to 50 oxyalkylene units, and X is chlorine, bromine, methyl sulfate, phosphate, hydroxide or nitrate.

Useful fluoroalkyl quaternary ammonium compounds include, for example, FC 135 (available from Minnesota Mining and Manufacturing, St. Paul, Minn.), Zonyl FSC and FSK (available from DuPont, Wilmington, Del.).

The cationic quaternary ammonium surfactant is present in the aqueous composition in an amount of no greater than 3% by weight, preferably from about 0.01% by weight to about 2% by weight, more preferably from about 0.01% by weight to about 1% by weight, most preferably from about 0.01% by weight to 0.5% by weight. The composition can be packaged as a concentrate for later dilution. In the concentrate form, the composition preferably includes cationic quaternary surfactant in an amount of from about 1% by weight to about 20% by weight, more preferably from about 2% by weight to about 10% by weight, most preferably from about 3% by weight to about 6% by weight.

Preferably the n-alkylalkoxysilane (or condensate thereof) and the cationic quaternary ammonium surfactant are present in the aqueous composition in a ratio of from about 1:1 to about 10:1, more preferably from about 1:1 to about 5:1.

The siloxane is preferably methylhydrogen siloxane having a formula of

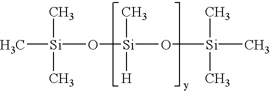

where y is from 1 to 50. Other useful siloxanes include, for example, methylhydrogen-methylalkyl siloxane copolymers (for example, methylhydrogen-dimethyl siloxane copolymers), methylhydrogen-cyclosiloxane copolymers and methylhydrogen-methylalkyl cyclosiloxane copolymers. The composition preferably includes siloxane in an amount of from 0.01% by weight to about 15% by weight, more preferably from about 0.1% by weight to about 10% by weight, most preferably from 0.5% by weight to about 5% by weight.

The volatile carrier volatilizes at room temperature (for example, about 25° C.) after application to a substrate. Useful volatile carriers include, for example, ethers, esters, glycols, glycol ethers, ethylacetate, glycol ether acetate, cyclomethicones and combinations thereof. Preferred volatile carriers include cyclomethicones having the formula

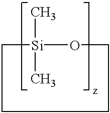

where z=4 to 6. A useful cyclosiloxane is octamethylcyclotetrasiloxane. The composition preferably includes volatile carrier in an amount of from 0.05% by weight to about 20% by weight, more preferably from about 0.05% by weight to about 10% by weight, most preferably from 0.05% by weight to about 5% by weight.

An example of a useful commercially available emulsion that includes methylhydrogen siloxane, cyclomethicone and n-alkylalkoxysilane, is available under the trade designation DC 2-1251 from Dow Chemical (Midland, Mich.) and includes methylhydrogen siloxane, octamethylcyclotetrasiloxane and n-octyltriethoxysilane.

The aqueous composition can optionally include emulsifiers including, for example, nonionic surfactants including, for example, polyoxyethylene alcohols, ethoxylated nonyl phenols, sorbitan fatty acid esters, fatty acid glycerides, polyoxyethylene sorbitan fatty acid esters and combinations thereof. Examples of useful commercially available nonionic surfactants are available under the trade designation BRIJ 35 and TERGITOL 15-s-3 polyoxyethylene alcohols from Dow Chemical, NP-6 and NP-7 ethoxylated nonyl phenol from Shell (Houston, Tex.), Span 20, 40, 60 and 80 fatty acid glycerides from Uniqema (Wilmington, Del.) and Tween 61 and 81 polyoxyethylene sorbitan fatty acid esters from Uniqema.

Preferably the aqueous composition has no greater than 15% by weight nonionic, anionic or amphoteric surfactant, more preferably no greater than 10% by weight nonionic, anionic or amphoteric surfactant, most preferably the aqueous composition is essentially free of nonionic, anionic and amphoteric surfactant, that is, has less than 5% by weight nonionic and anionic surfactant.

The aqueous composition may also include other additives including, for example, spreading agents, wetting agents, silica fillers, thickeners, pigment, preservatives, mildew deterrent agents fragrance, solvents, indicators, and combinations thereof.

The composition is moisture curable as it dries. Preferably at least one of the components of the composition forms a chemical bond to the surface of the porous substrate.

The composition is well suited for use in treating porous substrates including, for example, siliceous substrates including, for example, grout, concrete, clay, brick, stone, ceramic tile, plaster, roofing tile, driveways, garage floors, buildings, counter tops, and flooring, and calcareous substrates including, for example, marble, granite and limestone. The composition is also useful in treating substrates such as vinyl, wood, tile and carpet. The composition, when applied to a substrate and dried can provide functions including, for example, coating, sealing, protecting and combinations thereof.

Various application techniques can be used to treat a porous substrate with the aqueous composition including, for example, spraying, painting, dipping, soaking, mopping, and combinations thereof. The application technique can employ a variety of tools including, for example, brush, roller, sprayer, sponge, rag, mop and combinations thereof. The surface is preferably dry prior to application of the composition.

The substrate to be treated can also be pretreated, for example, cleaned, prior to treatment with the aqueous composition. Useful cleaning compositions include alkaline solutions and acid solutions. If acid solution is used, the substrate is preferably neutralized after application of the acid solution.

The invention will now be described by way of the following examples. All ratios and percentages are by weight unless otherwise indicated.

### EXAMPLES

Test Procedures

Test procedures used in the examples include the following.

Staining Test Method

Test Specimen Preparation Method

Sanded tile grout mixture (Custom, Seal Beuck, Calif.) is cast on vinyl tile, smoothed out on the surface of the vinyl tile, and allowed to air dry for at least 24 hours before use. The grout tile is then sectioned into from 12 to 16 staining areas 2 in.×6 in. (5 cm×15 cm) in dimension. Two grams of the stain resistant composition to be tested is applied to one section using a disposable pipette and then spread evenly across the section with a Q-tip cotton applicator. Other stain resistant compositions to be tested are applied to other sections of the tile and grout substrate and the coated sections are allowed to dry for 24 hours.

Test Specimen Evaluation Method

A disposable pipette is filled with a staining solution. Five droplets of staining solution are dispensed onto the test area. The droplets are allowed to remain on the test area for 20 minutes and then removed from the surface by wiping with a paper towel.

A solution of 6% Dawn dishing washing detergent in water is then repeatedly squirted onto the stained test sample using a pipette. The stained tile is then scrubbed using a 3M Scotch Brite scrubbing pad (Minnesota Mining and Manufacturing Company, St. Paul, Minn.) in an attempt to remove the stain. The sample is then rinsed with water and allowed to dry.

A picture of the test substrate is taken after scrubbing.

The staining is then observed and assigned a value from 0 to 5 using the following criteria: 5=no visible stain, 4=trace of stain visible, 3=outline of drop barely visible, 2=outline of drop visible, 1 dark outline of drop visible and 0=dark stain that has spread is visible.

Control 1

Control 1 was an untreated substrate. The untreated substrate was subjected to the Test Specimen Evaluation Method. The results are reported in Table 2.

Comparative Examples C1-C2

Comparative Example 1 was 8% DC 2-1251 emulsion (methylhydrogen siloxane, octamethylcyclotetrasiloxane and n-octyltriethoxysilane) (Dow Chemical Company, Midland, Mich.) and 92% distilled water.

Comparative Example 2 was 10% DC 2-1251 emulsion and 90% distilled water.

### Examples 1-19

The compositions of Examples 1-19 were prepared by combining DC 2-1251 emulsion (methylhydrogen siloxane, octamethylcyclotetrasiloxane and n-octyltriethoxysilane) (Dow Chemical Company, Midland, Mich.), AEM 5772 3-trimethoxysilylpropyldimethyloctadecyl ammonium chloride (50% solution) (Aegis Midland, Mich.) and distilled water in the amounts specified in Table 1 and mixing for 10 minutes.

The compositions of Comparative Examples C1-C2 and Examples 1-19 were tested on substrates as described in the Staining Test Method set forth above and the results are set forth in Table 2.

The oil repellency of the treated surface of Examples 1-19 was observed by placing a drop of oil on the surface of the treated substrate. For each of Examples 1-19, the drop of oil remained on the surface for twenty minutes and was removed by wiping with a paper towel.

TABLE 1

| Sample | % DC 2-1251 | % AEM 5772 | % DI Water |
|---|---|---|---|
| C1 | 8 | 0 | 92 |
| C2 | 10 | 0 | 90 |
| 1 | 8 | 4.60 | 87.40 |
| 2 | 10 | 4.60 | 85.40 |
| 3 | 8 | 5.80 | 86.20 |
| 4 | 8 | 3.00 | 89.00 |
| 5 | 8 | 1.75 | 90.25 |
| 6 | 8 | 1.20 | 90.80 |
| 7 | 8 | 0.58 | 91.40 |
| 8 | 8 | 0.30 | 91.70 |
| 9 | 8 | 0.12 | 91.88 |
| 10 | 7 | 0.58 | 92.40 |
| 11 | 7 | 0.30 | 92.70 |
| 12 | 6 | 1.20 | 92.80 |
| 13 | 6 | 0.58 | 93.40 |
| 14 | 6 | 0.30 | 93.70 |
| 15 | 6 | 0.12 | 93.88 |
| 16 | 5 | 0.30 | 94.70 |
| 17 | 5 | 0.12 | 94.88 |
| 18 | 4 | 0.30 | 95.70 |
| 19 | 4 | 0.12 | 95.88 |

TABLE 2

| | | | | | | | | | Total | |
|---|---|---|---|---|---|---|---|---|---|---|
| | | | | Total Oil | | | | | Water | |
| | | | | Stain | | | | | Stain | |
| | Vegetable | Transmission | Brake | Resistance | | Grape | | Red | Resistance | Total |
| Sample | Oil | Fluid | Fluid | Score | Wine | Juice | Coffee | Dye | Score | Score |
| Control 1 | 1 | 1 | 1 | 3 | 1 | 1 | 1 | 1 | 4 | 7 |
| (Untreated | | | | | | | | | | |
| Surface) | | | | | | | | | | |
| C1 | 2 | 1 | 2 | 5 | 5 | 4 | 4 | 4 | 17 | 22 |
| C2 | 2 | 1 | 3 | 6 | 4 | 5 | 4 | 4 | 17 | 23 |
| 1 | 5 | 3 | 5 | 13 | 4 | 4 | 4 | 2 | 14 | 27 |
| 2 | 5 | 3 | 5 | 13 | 4 | 5 | 4 | 2 | 15 | 28 |
| 3 | 5 | 3 | 5 | 13 | 3 | 4 | 4 | 2 | 13 | 26 |
| 4 | 5 | 3 | 5 | 13 | 3 | 5 | 4 | 4 | 16 | 29 |
| 5 | 5 | 3 | 5 | 13 | 5 | 5 | 5 | 4 | 19 | 32 |
| 6 | 5 | 3 | 5 | 13 | 5 | 5 | 5 | 5 | 20 | 33 |
| 7 | 5 | 4 | 5 | 14 | 5 | 5 | 5 | 4 | 19 | 33 |
| 8 | 5 | 4 | 5 | 14 | 5 | 5 | 5 | 4 | 19 | 33 |
| 9 | 5 | 4 | 5 | 14 | 4 | 5 | 3 | 4 | 16 | 30 |
| 10 | 5 | 4 | 5 | 14 | 5 | 5 | 3 | 3 | 16 | 30 |
| 11 | 5 | 4 | 5 | 14 | 5 | 5 | 4 | 5 | 19 | 33 |
| 12 | 5 | 4 | 5 | 14 | 4 | 5 | 3 | 3 | 15 | 29 |
| 13 | 5 | 4 | 5 | 14 | 4 | 4 | 3 | 4 | 15 | 29 |
| 14 | 5 | 4 | 5 | 14 | 5 | 5 | 4 | 4 | 18 | 32 |
| 15 | 5 | 2 | 5 | 12 | 5 | 4 | 3 | 4 | 16 | 28 |
| 16 | 5 | 3 | 5 | 13 | 5 | 3 | 2 | 3 | 13 | 26 |
| 17 | 5 | 3 | 5 | 13 | 5 | 4 | 3 | 4 | 16 | 29 |
| 18 | 5 | 2 | 5 | 12 | 5 | 4 | 2 | 3 | 14 | 26 |
| 19 | 5 | 2 | 5 | 12 | 5 | 3 | 2 | 4 | 14 | 26 |

Control 2

Control 2 was an untreated substrate. The untreated substrate was subjected to the Test Specimen Evaluation Method. The results are reported in Table 4.

Comparative Example C3

Comparative Example 3 included 8% DC 2-1251 (methylhydrogen siloxane, octamethylcyclotetrasiloxane and n-octyltriethoxysilane) emulsion and 92% distilled water.

### Examples 20-37

The compositions of Examples 20-37 were prepared by combining 1% BIOBAN DXN preservative (Dow Chemicals), and DC 2-1251 emulsion (methylhydrogen siloxane, octamethylcyclotetrasiloxane and n-octyltriethoxysilane), the cationic surfactant identified in Table 3 and distilled water in the amounts specified in Table 3, and then mixing for 10 minutes.

The compositions of Comparative Example C3 and Examples 20-37 were tested on substrates as described in the Staining Test Method set forth above. The results are set Table 4.

The oil repellency of the treated surface of Examples 20-37 was observed by placing a drop of oil on the surface of the treated substrate. For each of Examples 20-37, the drop of oil remained on the surface for twenty minutes and was removed by wiping with a paper towel.

TABLE 3

| | % DC 2- | | % Cationic | |
|---|---|---|---|---|
| Sample | 1251 | % DI Water | Surfactant | Cationic Surfactant Chemical Name |
| 20 | 6.5 | 92.2 | 0.3 | Octadecyltrimethyl ammonium chloride |
| 21 | 6.5 | 92.2 | 0.3 | Coco trimethyl ammonium chloride |
| 22 | 6.5 | 92.2 | 0.3 | Tallow trimethyl ammonium chloride |
| 23 | 6.5 | 92.2 | 0.3 | Dimethyl 80% behenyl benzyl |
| | | | | ammonium chloride |
| 24 | 6.5 | 92.2 | 0.3 | Soya trimethyl ammonium chloride |
| 25 | 6.5 | 92.2 | 0.3 | Methyl bis(2-hydroxyethyl)coco |
| | | | | ammonium chloride |
| 26 | 6.5 | 92.2 | 0.3 | Dehydrogenated tallow dimethyl |
| | | | | ammonium chloride |
| 27 | 6.5 | 92.2 | 0.3 | Methyldodecylbenzyl trimethyl |
| | | | | ammonium chloride |
| 28 | 6.5 | 92.2 | 0.3 | Lauryldimethylbenzyl ammonium |
| | | | | chloride |
| 29 | 6.5 | 92.2 | 0.3 | Alkyldimethyl-3,4-dichloro-benzyl |
| | | | | ammonium chloride |
| 30 | 6.5 | 92.2 | 0.3 | Octylphenoxyethoxyethyl dimethyl- |
| | | | | benzyl ammonium chloride |
| 31 | 6.5 | 92.2 | 0.3 | Octylcresoxyethoxyethyl dimethyl- |
| | | | | benzyl ammonium chloride |
| 32 | 6.5 | 92.2 | 0.3 | Cocoamidopropyl PG-dimonium |
| | | | | chloride phosphate |
| 33 | 6.5 | 92.2 | 0.3 | 2-hydroxyethylbenzyl stearyl |
| | | | | imidazolinium chloride |
| 34 | 6.5 | 92.2 | 0.3 | 1-hexadecylpyridinium chloride |
| 35 | 6.5 | 92.2 | 0.3 | Cetylpyridinium bromide |
| 36 | 6.0 | 92.7 | 0.3 | Stearyl dimethyl benzyl ammonium |
| | | | | chloride |
| 37 | 6.0 | 93.9 | 0.1 | Olealkonium chloride |

TABLE 4

| | | | | | | | | | Total | |
|---|---|---|---|---|---|---|---|---|---|---|
| | | | | Total Oil | | | | | Water | |
| | | | | Stain | | | | | Stain | |
| | Vegetable | Transmission | Brake | Resistance | | Grape | | Red | Resistance | |
| Sample | Oil | Fluid | Fluid | Score | Wine | Juice | Coffee | Dye | Score | Total |
| Control 2 | 1 | 1 | 1 | 3 | 2 | 1 | 1 | 1 | 5 | 8 |
| (Untreated | | | | | | | | | | |
| Surface) | | | | | | | | | | |
| C3 | 2 | 1 | 2 | 5 | 5 | 4 | 4 | 4 | 17 | 22 |
| 20 | 5 | 4 | 5 | 14 | 5 | 5 | 5 | 5 | 20 | 34 |
| 21 | 5 | 4 | 5 | 14 | 5 | 5 | 5 | 5 | 20 | 34 |
| 22 | 5 | 5 | 5 | 15 | 5 | 5 | 5 | 5 | 20 | 35 |
| 23 | 5 | 4.5 | 5 | 14.5 | 5 | 5 | 4 | 5 | 19 | 33.5 |
| 24 | 5 | 4.5 | 5 | 14.5 | 5 | 5 | 5 | 5 | 20 | 34.5 |
| 25 | 5 | 4 | 5 | 14 | 5 | 5 | 5 | 5 | 20 | 34 |
| 26 | 5 | 4 | 5 | 14 | 3 | 5 | 5 | 3 | 16 | 30 |
| 27 | 5 | 4 | 5 | 14 | 5 | 5 | 5 | 5 | 20 | 34 |
| 28 | 5 | 4 | 5 | 14 | 5 | 5 | 5 | 5 | 20 | 34 |
| 29 | 5 | 5 | 5 | 15 | 5 | 5 | 4 | 5 | 19 | 34 |
| 30 | 5 | 5 | 5 | 15 | 5 | 5 | 4.5 | 3 | 17.5 | 32.5 |
| 31 | 5 | 5 | 5 | 15 | 5 | 5 | 5 | 4.5 | 19.5 | 34.5 |
| 32 | 5 | 4 | 5 | 14 | 4 | 5 | 4 | 4.5 | 17.5 | 31.5 |
| 33 | 5 | 4 | 5 | 14 | 5 | 5 | 5 | 4.5 | 19.5 | 33.5 |
| 34 | 5 | 4 | 5 | 14 | 5 | 5 | 5 | 5 | 20 | 34.0 |
| 35 | 3 | 4.5 | 5 | 12.5 | 5 | 4 | 5 | 5 | 19 | 31.5 |
| 36 | 5 | 4.5 | 5 | 14.5 | 5 | 5 | 5 | 5 | 20 | 34.5 |
| 37 | 5 | 4.5 | 5 | 14.5 | 3 | 5 | 5 | 4.5 | 17.5 | 32.0 |

Other embodiments are within the following claims.

What is claimed is:

1. An aqueous composition comprising:
silane comprising n-alkylalkoxysilane, condensates of n-alkylalkoxysilane or a combination thereof; and
from about 0.01% by weight to about 2% by weight cationic quaternary ammonium surfactant.

2. The composition of claim 1, wherein said silane comprises n-octyltrialkoxysilane.

3. The composition of claim 1, wherein said silane is selected from the group consisting of n-octyltriethoxysilane and n-octyltrimethoxysilane.

4. The composition of claim 1, wherein said cationic quaternary ammonium surfactant comprises monoalkyl trimethyl quaternary ammonium compound.

5. The composition of claim 1, wherein said cationic quaternary ammonium surfactant is selected from the group consisting of dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

6. The composition of claim 1, wherein said cationic quaternary ammonium surfactant comprises a quaternary ammonium compound having the formula 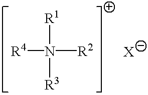
where R¹ is a methyl group or a saturated or unsaturated aliphatic group containing from 8 to 22 carbon atoms,
R² is a methyl group, a saturated or unsaturated aliphatic group containing from 8 to 22 carbon atoms, R′n or C(X¹)₂-benzyl, X¹ is hydrogen or halogen,
R³ is a methyl group or a saturated or unsaturated aliphatic group containing from 8 to 22 carbon atoms,
R⁴ is a methyl group, a saturated or unsaturated aliphatic group containing from 8 to 22 carbon atoms or R′n,
R′ is 2-hydroxyethyl or polyethoxyethanol,
n is from 1 to 50 oxyalkylene units,
at least one of R¹, R², R³ and R⁴, is a methyl group and at least one of R¹, R², R³ and R⁴ is a saturated or unsaturated aliphatic group containing from 8 to 22 carbon atoms, and
X is chlorine, bromine, methyl sulfate, phosphate, hydroxide or nitrate.

7. The composition of claim 1, wherein said cationic quaternary ammonium surfactant comprises a quaternary ammonium compound having the formula 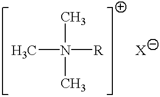
where R is a saturated or unsaturated aliphatic group containing from 8 to 22 carbon atoms, and X is chlorine, bromine, methyl sulfate, phosphate, hydroxide or nitrate.

8. The composition of claim 1, wherein said cationic quaternary ammonium surfactant comprises a quaternary ammonium compound having the formula 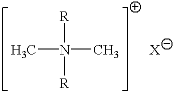
where each R is a linear or branched, saturated or unsaturated aliphatic group containing from 8 to 22 carbon atoms, and X is chlorine, bromine, methyl sulfate, phosphate, hydroxide or nitrate.

9. The composition of claim 1, wherein said cationic quaternary ammonium surfactant comprises a quaternary ammonium compound having the formula 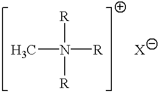
where each R is a linear or branched, saturated or unsaturated aliphatic group containing from 8 to 22 carbon atoms, and X is chlorine, bromine, methyl sulfate, phosphate, hydroxide or nitrate.

10. The composition of claim 1, wherein said cationic quaternary ammonium surfactant comprises a quaternary ammonium compound having the formula: 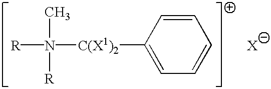
where each R is a linear or branched, saturated or unsaturated aliphatic group containing from 8 to 22 carbon atoms, X¹ is hydrogen or halogen, and X is chlorine, bromine, methyl sulfate, phosphate, hydroxide or nitrate.

11. The composition of claim 1, wherein said cationic quaternary ammonium surfactant comprises a quaternary ammonium compound having the formula 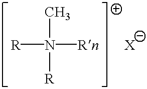
where each R is a linear or branched, saturated or unsaturated aliphatic group containing from 8 to 22 carbon atoms, R′ is 2-hydroxyethyl or polyethoxyethanol, n is from 1 to 50 polyoxyalkylene units, and X is chlorine, bromine, methyl sulfate, phosphate, hydroxide or nitrate.

12. The composition of claim 1, wherein said cationic quaternary ammonium surfactant comprises cationic quaternary ammonium compound having the formula 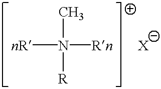
where, each R is a linear or branched, saturated or unsaturated aliphatic group containing from 8 to 22 carbon atoms, R′ is 2-hydroxyethyl or polyethoxyethanol, n is from 1 to 50 oxyalkylene units, and X is chlorine, bromine, methyl sulfate, phosphate, hydroxide or nitrate.

13. The composition of claim 1, wherein said cationic quaternary ammonium surfactant comprises organosilane quaternary ammonium compound.

14. The composition of claim 1, wherein said cationic quaternary ammonium surfactant comprises fluoroalkyl quaternary ammonium compound.

15. The composition of claim 1, wherein said composition includes no greater than 1% by weight cationic quaternary ammonium surfactant.

16. The composition of claim 1, wherein said composition includes from about 0.01% by weight to about 0.5% by weight said cationic quaternary ammonium surfactant.

17. The composition of claim 1, wherein the ratio of said n-octyltriethoxysilane to said cationic quaternary ammonium surfactant is from about 1:1 to about 10:1.

18. The composition of claim 1, wherein the ratio of said n-octyltriethoxysilane to said cationic quaternary ammonium surfactant is from about 1:1 to about 5:1.

19. The composition of claim 1, further comprising siloxane comprising methylhydrogen siloxane, methylhydrogen-methylalkyl siloxane copolymer, methylhydrogen-cyclosiloxane copolymer, methylhydrogen-methylalkyl cyclosiloxane copolymer or a combination thereof.

20. The composition of claim 1, further comprising a volatile carrier.

21. The composition of claim 19, wherein said volatile carrier comprises cylcomethicone having the formula 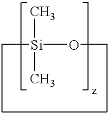
where z=4 to 6.

22. The composition of claim 1, further comprising octamethylcyclotetrasiloxane.

23. The composition of claim 1, wherein said composition further comprises nonionic surfactant.

24. The composition of claim 23, wherein said nonionic surfactant is selected from the group consisting of polyoxyethylene alcohol, ethoxylated nonyl phenol, sorbitan fatty acid ester, fatty acid glycerides, polyoxyethylene sorbitan fatty acid esters and combinations thereof.

25. The composition of claim 1, wherein said composition is essentially free of nonionic surfactant and anionic surfactant.

26. The composition of claim 1, wherein said composition includes from about 0.1% by weight to about 3% by weight silane selected from the group consisting of n-alkylalkoxysilane, condensates of n-alkylalkoxysilane and combinations thereof.

27. The composition of claim 1, wherein said composition includes from about 0.01% by weight to about 0.5% by weight said cationic quaternary ammonium surfactant.

28. The composition of claim 1, wherein the ratio of said silane to said cationic quaternary ammonium surfactant is from about 1:1 to about 10:1.

29. The composition of claim 1, wherein the ratio of said silane to said cationic quaternary ammonium surfactant is from about 1:1 to about 5:1.

30. An aqueous composition comprising:
siloxane selected from the group consisting of methyl hydrogen siloxane, methylhydrogen-methylalkyl siloxane copolymer, methylhydrogen-cyclosiloxane copolymer, methylhydrogen-methylalkyl cyclosiloxane copolymer and combinations thereof;
silane comprising n-alkylalkoxysilane, condensates of n-alkylalkoxysilane or a combination thereof;
volatile carrier; and
cationic quaternary ammonium surfactant.

31. The composition of claim 30, wherein said siloxane comprises methyl hydrogen siloxane.

32. The composition of claim 30, wherein said silane comprises n-octyltrialkoxysilane.

33. The composition of claim 30, wherein said silane is selected from the group consisting of n-octyltriethoxysilane and n-octyltrimethoxysilane.

34. The composition of claim 30, wherein said cationic quaternary ammonium surfactant comprises monoalkyl trimethyl quaternary ammonium compound.

35. The composition of claim 30, wherein said cationic quaternary ammonium surfactant is selected from the group consisting of dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

36. The composition of claim 30, wherein said composition includes no greater than 1% by weight cationic quaternary ammonium surfactant.

37. The composition of claim 30, wherein said composition includes from about 0.01% by weight to about 0.5% by weight said cationic quaternary ammonium surfactant.

38. The composition of claim 30, wherein the ratio of said silane to said cationic quaternary ammonium surfactant is from about 1:1 to about 10:1.

39. The composition of claim 30, wherein the ratio of said silane to said cationic quaternary ammonium surfactant is from about 1:1 to about 5:1.

40. The composition of claim 30, wherein said volatile carrier comprises cyclomethicone.

41. The composition of claim 30, further comprising octamethylcyclotetrasiloxane.

42. The composition of claim 30, wherein said composition is essentially free of nonionic surfactant and anionic surfactant.

43. An aqueous composition comprising:
methylhydrogen siloxane;
octamethylcyclotetrasiloxane;
n-octyltriethoxysilane; and
cationic quaternary ammonium surfactant.

44. The composition of claim 43, further comprising nonionic surfactant.

45. The composition of claim 43, wherein said cationic quaternary ammonium surfactant is selected from the group consisting of monoalkyl trimethyl quaternary ammonium compounds, dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

46. The composition of claim 43, wherein said cationic quaternary ammonium surfactant comprises a quaternary ammonium compound having the formula 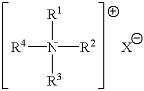
where R¹ is a methyl group or a saturated or unsaturated aliphatic group containing from 8 to 22 carbon atoms,
R² is a methyl group, a saturated or unsaturated aliphatic group containing from 8 to 22 carbon atoms, R′n or C(X¹)₂-benzyl where X¹ is hydrogen or halogen,
R³ is a methyl group or a saturated or unsaturated aliphatic group containing from 8 to 22 carbon atoms,
R⁴ is a methyl group, a saturated or unsaturated aliphatic group containing from 8 to 22 carbon atoms or R′n,
R′ is 2-hydroxyethyl or polyethoxyethanol,
n is 1-50,
at least one of R¹, R², R³ and R⁴, is a methyl group and at least one of R¹, R², R³ and R⁴ is a saturated or unsaturated aliphatic group containing from 8 to 22 carbon atoms, and
X is chlorine, bromine, methyl sulfate, phosphate, hydroxide or nitrate.

47. A method of treating a porous substrate, said method comprising:
a. contacting a porous substrate with an aqueous composition comprising
silane comprising n-alkylalkoxysilane, condensates of n-alkylalkoxysilane or a combination thereof, and
from about 0.01% by weight to about 2% by weight cationic quaternary surfactant; and
b. drying said composition on said substrate.

48. The method of claim 47, further comprising cleaning said porous substrate prior to contacting said porous substrate with said aqueous composition.

49. The method of claim 47, wherein said porous substrate is selected from the group consisting of grout, plaster, stucco, concrete, tile, brick, stone, glass and combinations thereof.

50. The method of claim 47, wherein said stone is selected from the group consisting of slate, marble, terrazzo, granite, limestone, and combinations thereof.

51. The method of claim 47, wherein said cationic quaternary ammonium surfactant comprises monoalkyl trimethyl quaternary ammonium compound.

52. The method of claim 47, wherein said cationic quaternary ammonium surfactant is selected from the group consisting of dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

53. The method of claim 47, wherein said aqueous composition further comprises siloxane comprising methylhydrogen siloxane, methylhydrogen-methylalkyl siloxane copolymer, methylhydrogen-cyclosiloxane copolymer, methylhydrogen-methylalkyl cyclosiloxane copolymer or a combination thereof.

54. The method of claim 47, wherein said aqueous composition further comprises cyclomethicone having the formula 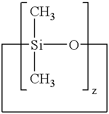
where z=4 to 6.

55. The method of claim 54, wherein said methicone comprises octamethylcyclotetrasiloxane.

56. The method of claim 54, wherein said silane comprises n-octyltriethoxysilane.

57. The method of claim 54, wherein said siloxane comprises methylhydrogen siloxane and said n-alkylalkoxysilane comprises n-octyltriethoxysilane.

58. An aqueous composition comprising:
methylhydrogen siloxane;
octamethylcyclotetrasiloxane;
n-octyltriethoxysilane; and
cationic quaternary ammonium organosilane compound.

59. An article comprising:
a porous substrate; and
a composition disposed on said porous substrate, said composition comprising
silane comprising n-alkylalkoxysilane, condensates of n-alkylalkoxysilane or a combination thereof, and
from about 0.01% by weight to about 2% by weight cationic quaternary ammonium surfactant.

60. The article of claim 59, wherein said composition is chemically bonded to said porous substrate.

61. The article of claim 60, wherein said porous substrate is selected from the group consisting of grout, plaster, stucco, concrete, tile, brick, stone, glass and combinations thereof.

62. The article of claim 59, wherein said porous substrate is selected from the group consisting of slate, marble, terrazzo, granite, limestone, and combinations thereof.

63. The article of claim 59, wherein said silane comprises n-octyltriethoxysilane.

64. The article of claim 59, wherein said composition comprises the reaction product of said silane and siloxane selected from the group consisting of methylhydrogen siloxane, methylhydrogen-methylalkyl siloxane copolymer, methylhydrogen-cyclosiloxane copolymer, methylhydrogen-methylalkyl cyclosiloxane copolymer and combinations thereof.

65. The article of claim 59, wherein said siloxane comprises methylhydrogen siloxane and said silane comprises n-octyltriethoxysilane.

66. The article of claim 59, wherein said cationic quaternary ammonium surfactant is selected from the group consisting of monoalkyl trimethyl quaternary ammonium compounds, dialkyl dimethyl quaternary ammonium compounds, trialkyl monomethyl ammonium compounds, benzyl quaternary ammonium compounds, alkoxy alkyl quaternary ammonium compounds, ester quaternary ammonium compounds, imidazolinium quaternary ammonium compounds, diamidoamine quaternary ammonium compounds and combinations thereof.

67. An article comprising:
a porous substrate; and
a composition disposed on said porous substrate, said composition comprising
siloxane selected from the group consisting of methyl hydrogen siloxane, methylhydrogen-methylalkyl siloxane copolymer, methylhydrogen-cyclosiloxane copolymer, methylhydrogen-methylalkyl cyclosiloxane copolymer and combinations thereof;
silane comprising n-alkylalkoxysilane, condensates of n-alkylalkoxysilane or a combination thereof;
volatile carrier; and
cationic quaternary ammonium surfactant.

68. The article of claim 67, wherein said composition comprises methylhydrogen siloxane, octamethylcyclotetrasiloxane, n-octyltriethoxysilane, and cationic quaternary ammonium surfactant.

69. The article of claim 67, wherein said porous substrate is selected from the group consisting of grout, plaster, stucco, concrete, tile, brick, stone, glass and combinations thereof.

70. The article of claim 67, wherein said porous substrate is selected from the group consisting of slate, marble, terrazzo, granite, limestone, and combinations thereof.

71. A stain resistant composition comprising
a. silane comprising n-alkylalkoxysilane, condensates of n-alkylalkoxysilane or a combination thereof; and
b. from about 0.01% by weight to about 2% by weight cationic quaternary surfactant,
said composition imparting greater stain resistance to a porous substrate treated with said composition relative to the stain resistance of the untreated porous substrate.
